(19) United States
(12) Patent Application Publication
(10) Pub. No.: US 2007/0138703 A1
(43) Pub. Date: Jun. 21, 2007

(54) Method and apparatus for manufacturing a concrete product

(76) Inventor: Paavo Ojanen, Valkeakoski (FI)

Correspondence Address: HARNESS, DICKEY & PIERCE, P.L.C., P.O. BOX 8910, RESTON, VA, 20195, US

(21) Appl. No.: 10/554,799

(22) PCT Filed: May 14, 2004
(86) PCT No.: PCT/FI04/00296

§ 371 Date: Feb. 6, 2007

(30) Foreign Application Priority Data
May 15, 2003 (FI) 20030733

(51) Int. Cl. B28B 3/00

(52) U.S. Cl. 264/333; 425/200

(57) ABSTRACT

A new type of concrete-casting machine, by means of which it will be possible to manufacture products with more diverse shapes than previously and which will have both less component wear and less need for maintenance, the concrete being cast being fed into a shaping chamber forming the cross-section of the product, in such a way that, in at least one feed stage, the concrete is fed under pressure to the shaping chamber, in such a way that its flow direction differs from the direction of casting. In the first stage (6), the wet concrete mass is fed onto the casting bed (1). In at least one following stage (7), the wet concrete mass is fed together with the mass fed in the first stage, and, in at least one feed stage (7) after the first feed stage (6), the wet concrete mass is fed under pressure.

The present invention relates to a method, according to the preamble of claim 1, for manufacturing concrete products. The method is applicable to the manufacture of solid slabs, hollow-core slabs, and other products with varied profiles.

The invention also relates to an apparatus for use in applying the method.

The construction industry uses large numbers of different concrete manufactured products, which are prefabricated in factories. Such products are, for example, slabs, columns, and prefabricated units. Known methods of manufacturing elongated concrete products are the extrusion technique and the slip-former technique. These methods have been in general use since the end of the 1960s. They are typically used to manufacture prefabricated floor units and simple beam profiles.

In the extrusion technique concrete is fed by screws through nozles and shaping elements onto an elongated formwork bed. The shafts of the screws are parallel to the casting bed and thus the casting and the shaping elements, with the aid of which, for example, hollow cores can be made in units, are also extensions of the screws. The most typical products are hollow-core slabs, which in practice have become standardized at 1200-mm wide and 150-400-mm thick. Compaction of the concrete takes place with the aid of the feed pressure of the screws and vibration, or of the feed pressure of the screws and mechanical compaction movements, i.e. rubbing compaction. In the method, it is typically possible to use very stiff concrete and it generally achieves good compaction and strength in the concrete. Thanks to the stiff mass, the cast product retains its shape immediately after casting, which is a precondition for the manufacture of hollow products. The weaknesses of the method are a relatively low casting speed and the limited shape and number of cross-sections. The cross-section of a product being manufactured can be varied mainly by altering its outer dimensions and varying the height and width of the hollow cores. Because the feed screws lie on the same axis as the hollow cores, in practice it is impossible to alter, for example, the mutual distance between the cavities, or else this requires a great deal of time, due to the large amount of installation work involved. The diameter of the feed screws also determines the shape and size of the hollow cores, as the high feed pressure large prevents changes being made in the cross-section in the area of the nozzles. This means, for example, that the hollow core cannot be substantially larger than the diameter of the feed screw. A problem with extruder casting machines is also the heavy wear in the screws and other components, which is due to the high feed pressure and the forces arising in feeding the stiff mass. The concrete mix and other casting properties must also be precisely controlled.

In the slip-former technique, concrete is fed with the aid of gravity into the space defined by the shaping elements through the dosing hatches of the casting machine. The concrete is generally fed in one or two stages, compaction taking place without external pressure, with the aid of vibration and mechanical compaction movements. Generally, the method can be used to cast more diverse shapes than when using extrusion. Typical shapes can be hollow-core slabs, solid slabs, T-sections, and various bracket profiles. Because the creation of pressure in the method mainly depends hydrostatic pressure arising from the effect of the Earth's gravity, the compaction effect and stiffness of the concrete are less than in the extrusion method. The controllability of the concrete feed, the homogeneity of the cross-sections, and dimensional accuracy are also poor.

In addition, there are other methods, which are typically less mechanized and are not as competitive in terms of productivity as the more highly developed methods referred to above.

The invention is intended to create a new type of concrete-casting machine, by means of which products with more diverse shapes than previously can be manufactured and which will have both less component wear and less need for maintenance.

The invention is based on the casting concrete being fed into a shaping chamber forming the cross-section of the product in such a way that, in at least one stage of the feed, the concrete is fed into the shaping chamber under pressure, in such a way that its direction of flow differs from the direction of casting.

More specifically, the concrete-casting method according to the invention is characterized by what is stated in the characterizing portion of claim 1.

The apparatus according to the invention is, in turn, characterized by what is stated in the characterizing portion of claim 9.

Considerable advantages are gained with the aid of the invention.

It is easy to create and regulate the feed pressure of the concrete, for which purpose both the pressure of the second-stage feed screws and the piston-like motion of the cores can be used. The motion of the cores is used to create a powerful pressing compaction effect, without causing the mechanical stress that arises in compaction carried out with the aid of conventional feed screws. The shape of the cores can be relatively freely selected, as can the cross-section of the product being shaped, allowing quite an extensive product range to be manufactured with the aid of the method and the apparatus. This is made possible by the feed pressure of the mass in the second feed stage being created with the aid of separate feed screws, so that the pressure in the second feed stage can be well controlled, irrespective of the shape of the cross-section being manufactured. Thanks to the good and easily controlled compaction, the quality of the products being manufactured is even. Masses with different properties can be used in different stages of casting, thus affecting the colour, strength, surface structure, and other properties of the product, by varying the mix, additives, and even the fillers and reinforcing substances of the mass. The casting speed of the machine can be very high, as in principles there are no restrictions to the mass-feed speed in the first stage. Due to the small feed capacity of the second-stage screws, the cores or pistons also carry out a large part of the feed, and, thanks to the controlled pressure and the effective mechanical compaction, the speed can be very high. As the measurement of the pressure acting on the compaction beam forming the upper edge of the product is used to regulate the feed screws, it is easy to regulate the pressure of the concrete in the nozzle area in the cross-section performing the shaping. The movement of the concrete fed by the feed screws can be controlled by giving the compaction beam, for example, a gutter-like shape. By combining the movement of the mass guides with the motion of the cores, the feed can be made even more powerful. The machine can operate like an extruder with the aid of the reaction force of the screws and pistons, or it can be used to cast efficiently with the aid of the traction of the drive motors. Thus, the form of operation can be adapted to suit the mass being used and the product. In the machine according to the invention, the properties of an extruder casting machine, a slip-former machine, and a casting machine using piston compaction can be combined, and the best properties of each type of machine can be exploited, in order to optimize the manufacture and properties of the products being made.

In the following, the invention is examined with the aid of examples and with reference to the accompanying drawings.

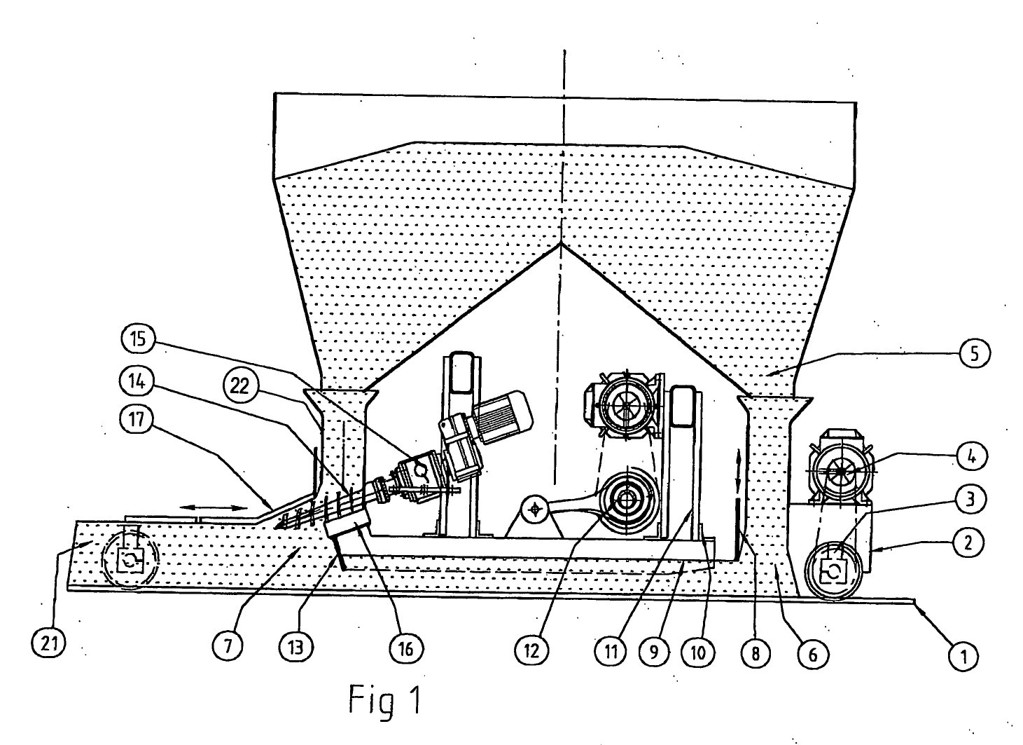

FIG. 1 shows a side view of a partial cross-section of the concrete-casting machine according to the invention.

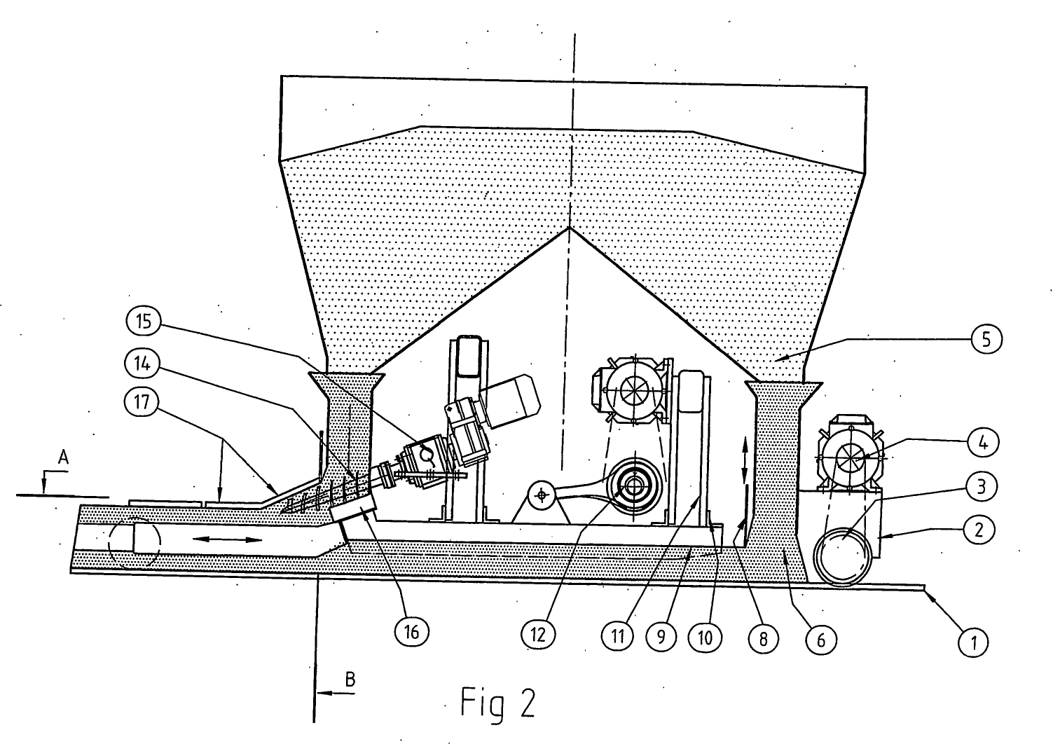

FIG. 2 shows a side view of a partial cross-section of a second embodiment of the invention.

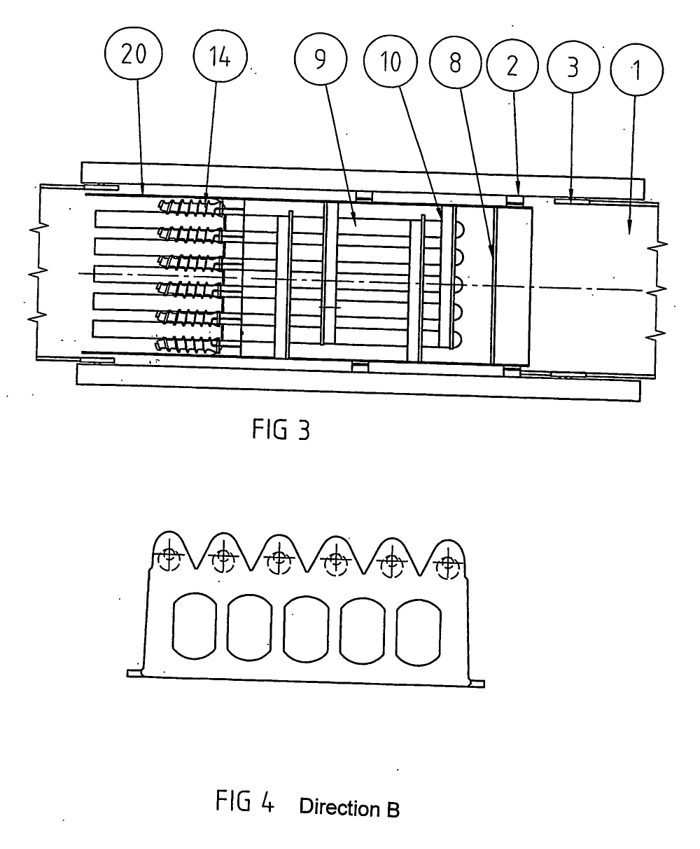

FIG. 3 shows a cross--section A of the embodiment of FIG. 2.

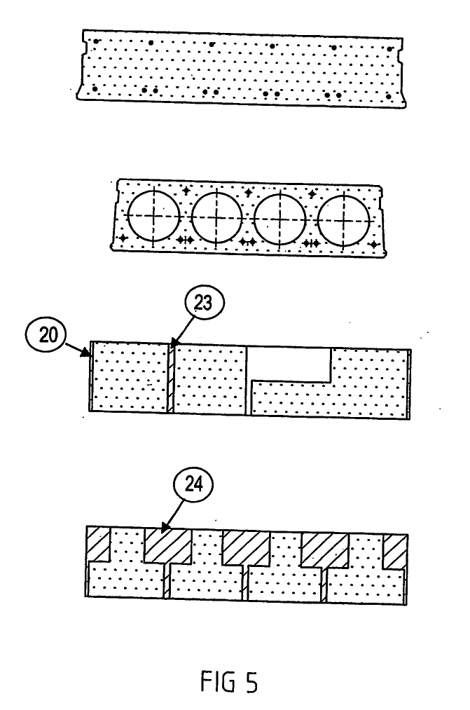

FIG. 4 shows a cross-section B of the embodiment of FIG. 2.

FIG. 5 shows various shapes of profile, which can be manufactured with the aid of the invention.

The concrete product is cast on a casting bed 1, along which the casting machine travels, for example, on edge rails. In the machine, there is a frame 2 and drive wheels 3, which are driven by a drive device 4. If necessary, the machine can also travel and cast the product without the drive device, with the aid of the reaction force of the pressure created by the concrete, but a drive device is preferred for moving the machine and for controlling the pressure arising from compaction during casting. At the top of the machine there is a concrete tank 5, which is shaped in such a way that concrete can be fed in two stages into the product being manufactured. In the first stage, the casting layer of concrete is fed into the formwork at point 6, its amount being regulated with a scraper plate 8. The height of the scraper plate can be adjusted, for example, with the aid of screws or sprockets. The amount of concrete fed in the first stage can be varied, being usually 10-80% of the total amount. If all of the concrete is fed onto the casting bed 1 in this first stage, the machine will act like a slip-former machine and it can be used to manufacture products suitable for slip-former casting. The greater the amount of concrete fed in this first stage, the smaller the wearing flow in the pressurized feed of the second stage.

The wet concrete mass fed in the first stage 6 travels under and between the cores 9. There can be several cores 9 next to each other, which are used to compact and shape the concrete layer fed in the first stage. The cores 9 can be fixed in place, but in this embodiment they are arranged to move backwards and forwards longitudinally. The cores 9 shape the concrete in the first stage and compact the concrete. The cores 9 are connected to each other with the aid of transverse beams 10, which divide the cores into two groups, in such a way that adjacent cores can always move in opposite directions (FIG. 3). The cores 9 move on swing arms. Motion is achieved, for example, with the aid of a known eccentric-crankshaft mechanism 12. Piston plates 13 are attached to the ends of the cores 9, by which means the feed of the concrete is boosted in the second stage and the concrete in the compaction space 7 in front of the piston plates is compacted by the pressing movement. The piston plates 13 are located particularly in the upper part of the product being manufactured and the height of their lower edge is determined according to the amount of concrete being fed in the first stage.

The concrete of the second stage is fed at point 7 and acts as the actual compaction zone of the concrete. The second-stage feed elements comprise a feed shaft 22 and feed screws 14, which extend from the bottom end of the feed shaft to the upper part of the compaction zone, in front of the piston plates 13. In the second stage, the necessary additional concrete is fed by gravity, with the aid of the feed screws 14. The pressure effect of the feed screws 14, together with the compression of the piston plates, creates effective compaction. The screws 14 are rotated by conventional drive devices, for example, back-drive motors 15. Mass guides 16 are used to control the feed of the concrete, and are fitted above the feed screws. In the case of this example, the mass guides are connected to the cores 9 and thus also make a backwards and forwards movement, and make the feed of the concrete more effective. The mass guides can be gutter shaped and conform to the shape of the circumference described by the screws 14. The upper surface of the product is shaped with the aid of the compaction beam 17. The machine's nozzle component, shown in FIG. 1, which determines the outer shape of the product, comprises side walls 20, the casting base 1, and a compaction beam 17. The edge of the compaction beam 17 on the feed-screw 14 side is arranged at the same angle as the feed screws, thus giving the compaction zone a narrowing cross-section. During casting, the compaction beam is moved backwards and forwards more or less parallel to the casting, with the aid of known, for example, eccentric-crankshaft mechanisms. The compaction effect shaping the product depends on how great a pressure is used to feed the concrete to the compaction zone in the second feed stage. In order to measure and monitor this pressure, a pressure or force sensor, or sensors is/are placed on the compaction beam 17, the feed power of the screws being monitored on the basis on the measurement. Because the second-stage mass feed is mainly intended to create a compacting pressure in the compaction zone 7, regulation of the correct pressure is essential to the operation of the device. The product 21 manufactured using the machine of FIG. 1 can be, for example, a solid slab profile, or a so-called installation slab.

FIG. 2 shows a solution that differs at point 1 from that shown. In this case, the core 9 is extended with the aid of hollow-core components 18, in such a way that the hollow-core components extend through the compaction zone. By using hollow cores, the profiles being cast can be shaped in diverse ways, to produce, for example, hollow-core slabs, hollow piles, T-beams, and other beam and pile profiles. It is then also preferable to use piston plates 13 at the collar of the cores, in order to make the feed and compaction more efficient. In this embodiment, it is possible to use partitions between the hollow beams, with the aid of which the nozzle component is divided into parallel sectors. In this way, it is possible to manufacture several products simultaneously next to each other. The cross-section of the continuation cores can vary in the compaction zone, so that it will be possible to create, for example, a slightly narrowing cross-section. This makes it possible to control effectively the mass flows in the nozzle area and the compaction of the concrete.

The feed screws 14 according to the invention are tilted in a position differing from the direction of the casting, at an acute angle to the casting moving under them. This gives the mass an advantageous flow direction. Structurally, it is preferable to install the feed screws on top of the machine above the core lines, particularly in such a way that they extend above the compaction zone. Thus the screws are distributed above the cores and the hollow cores and the feed of the wet concrete mass can be arranged advantageously using gravity from a tank above the screws. Also the cores 9 can be set in a tilted position, especially when casting solid cross-sections. The cores can be, for instance, at the same angle relative to the feed direction as the feed screws. The feed screws can be envisaged as being at the sides of the machine, but in that case the profiles being cast should be narrow, in order to be able to ensure the feed to the centre line of the machine.

The compaction beam 17 is preferably shaped in the form of a gutter at the location of the feed screws. The shape of the gutters can be cylindrical, conical, or rectangular. In this way, the free volume in the compaction space is reduced and the feed of the mass is directed more effectively and smoothly. The feed power of the screws is also directed directly onto the mass being fed and there is no need to pressurize the large mass volume unnecessarily.

FIG. 5 shows various profiles, which can be manufactured using the machine according to the invention. The uppermost is a simple solid slab, in which the upper and lower surfaces are flat. The next product is a conventional hollow-core slab, which includes four hollow cores. In the solution shown beneath the hollow-core slab, two square beams and one L beam are made in the same casting. The casting can be carried out in such a way that the square beams are divided from each other by using partitions 23 fitted as continuations of the cores 9, while the L beam is shaped using a shaping core. The entire casting area is delimited by the side walls 20 of the casting machine. In the lowermost solution, partitioning extensions 24 of the cores are used to divide the casting area into four parts and form the flanges of the T beams. This allows four identical beams to be manufactured parallel to each other. As can be seen from the above examples, the cross-section of the casting can be varied relatively freely with the aid of extensions to the cores, which is not possible, for example, in an extruder-casting machine. The number of products manufactured simultaneously depends, of course, on the width of the machine, but generally the width of the machine is designed to correspond to the width of a standard slab, in which case the greatest width is 1200 mm.

The construction according to the invention can, however, be used to manufacture considerably wider products too, and for such products it is cheaper than previous solutions, because the concrete feed forces can be kept moderate and a wide machine is easier to construct. On the other hand, the compaction result is considerably better than that of a conventional slip-former casting machine.

Embodiments of the invention, differing from those disclosed above, can also be envisaged within the scope of the invention. In particular, the concrete tank can be divided into two parts, so that is will be easy to use different wet concrete masses, if necessary. Of course, the mass can be envisaged as being fed in even more stages, so that it is possible to use, for instance, two pressurized feed stages. In special cases, pressurized mass feed can be used in the first stage too, in order to further improve compaction. This seems to give the greatest benefit when there is a large mass to be fed in the first stage. Because, in the above embodiments, an actual nozzle-specific compaction area is not formed in the first stage, there is little benefit in pressurized feed. Thus, when striving for an improved compaction effect, it is preferable to make the first-stage feed too through the nozzle area. This required the wet concrete mass to be fed through a limited cross-section, in the same way as in the second stage.

One preferred application of the invention is the feed of the concrete only using feed screws 14 and under pressure directly to the compaction zone. Thus, the first feed stage is eliminated. In this form of use and embodiment, it is important to use a backwards and forwards pressing compaction motion of the cores 9, which is preferably boosted using piston plates or similar. As such, the movement of the cores can be left out, but it will then be difficult to arrange a smooth flow of the concrete in the compaction space and the compaction result will be poorer when one form of compaction is eliminated.

It is obvious that the number of feed screws, cores, core extensions, and other components of the machine can be varied as required. In the apparatus according to the invention, it is easy to change the cores and the number of them and the distances between them, because the cores are not extensions of the feed screws and thus need not be connected to the drive machinery. As stated above, the cores are installed, for example, in simple transverse beams, to and from which they can be easily attached and detached.

1. A method for manufacturing a concrete product, in which method:
concrete mass is fed onto a casting base in at least one stage and
the concrete mass is fed through a restricted cross-section, in order to form the product,
wherein the concrete mass is fed in at least one feeding stage under pressure through the restricted cross-section, in such a way that the direction of the mass feed differs from the direction of the casting.

2. A method according to claim 1, wherein
the wet concrete mass is fed onto the casting base in a first stage,
in at least one following stage, a wet concrete mass is fed together with the mass fed in the first stage, and
the wet concrete mass is fed under pressure in at least one feed stage after the first feed stage.

3. A method according to claim 2, in which method the wet concrete mass is fed in the first stage between cores in and above the casting base, wherein, in the second stage, the mass is fed in front of the cores from above the line of the cores.

4. A method according to claim 2, wherein the wet concrete mass is fed in the second stage with the aid of feed screws fitted above the cores and set at a slant relative to the direction of casting.

5. A method according to claim 1, wherein the wet concrete mass is pressed into the restricted cross-section by moving the cores backwards and forwards in the direction of the cross-section.

6. A method according to claim 1, wherein the shape of the wet concrete mass fed through the restricted cross-section is altered using extensions to the cores, which are arranged to travel through the restricted cross-section.

7. A method according to claim 1, wherein at least two separate wet concrete masses are used.

8. A method according to claim 1, wherein one of the elements forming the restricted cross-section is a compaction beam and the force or pressure acting on the compaction beam is measured and the pressure is regulated on the basis of the measurement result, by adjusting the feed of the feed screws in the compaction area formed by the restricted cross-section.

9. An apparatus for manufacturing a concrete product, which apparatus includes:
elements for forming a restricted cross-section, which elements include at least a casting bed, side walls at its sides, and a compaction beam above it and
elements for feeding a wet concrete mass through the restricted cross-section in order to form the product,
wherein by feed screws, which are arranged to feed the mass under pressure in at least one feed stage to the restricted cross-section, in such a way that the feed direction of the mass differs from the direction of the casting.

10. An apparatus according to claim 9, wherein
by elements for feeding the wet concrete mass onto the casting bed in the first stage,
elements for feeding the concrete mass in at least one following stage together with the mass fed in the first stage.

11. An apparatus according to claim 9, wherein by cores, which are arranged above the casting bed, in such a way that the wet concrete mass can be fed in the first stage between the casting bed and the cores.

12. An apparatus according to claim 9, wherein by piston plates on the cores' side of the restricted cross-section, for pressing the wet concrete mass towards the restricted cross-section.

13. An apparatus according to claims 9, wherein the feed screws are located above the cores an acute angle relative to the direction of casting.

14. An apparatus according to claims 9, wherein by elements for measuring the force or pressure acting on the compaction beam.
